(19) United States
(12) Patent Application Publication
(10) Pub. No.: US 2026/0019852 A1
(43) Pub. Date: Jan. 15, 2026

(54) TECHNIQUES FOR INTERFERENCE HANDLING IN DYNAMIC TIME DIVISION DUPLEX OPERATION

(71) Applicant: Lenovo (Singapore) Pte. Ltd., Singapore (SG)

(72) Inventors: Hyejung Jung, Northbrook, IL (US); Majid Ghanbarinejad, Chicago, IL (US); Hossein Bagheri, Dearborn Heights, MI (US); Vijay Nangia, Woodridge, IL (US)

(21) Appl. No.: 18/992,540

(22) PCT Filed: Jul. 10, 2023
(86) PCT No.: PCT/IB2023/000403

§ 371 Date: Jan. 8, 2025

Related U.S. Application Data
(60) Provisional application No. 63/359,657, filed on Jul. 8, 2022.

(51) Int. Cl. H04W 24/10; H04B 17/345

(52) U.S. Cl. CPC H04W 24/10; H04B 17/345

(57) ABSTRACT

Various aspects of the present disclosure relate to interference handling in dynamic time division duplex operation. An apparatus is configured to receive a configuration comprising a set of resources, wherein a resource of the set of resources is configured for cross-link interference (CLI) measurement based on an indication and perform the CLI measurement on the resource based at least in part on whether the indication is received, wherein the indication indicates to perform the CLI measurement on the resource.

### FIELD

The present disclosure relates to wireless communications, and more specifically to interference handling in dynamic time division duplex operation.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### BRIEF SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of” indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further include at least one memory and at least one processor coupled with the at least one memory. The at least one processor may be configured to cause a UE to receive a cross-link interference (CLI) measurement configuration comprising at least one CLI resource, wherein a CLI resource of the at least one CLI resource is configured with a dynamic indication, monitor the dynamic indication for the CLI resource of the at least one CLI resource, and perform a measurement on the CLI resource in response to the dynamic indication indicating that the CLI resource available for measurement.

In some implementations of the method and apparatuses described herein, at least one processor is coupled with the at least one memory to cause a base station to transmit a CLI measurement configuration to a UE, the CLI measurement configuration comprising at least one CLI resource, wherein a CLI resource of the at least one CLI resource is configured with a dynamic indication of a validity of a CLI measurement occasion of the CLI resource, determine the validity of the CLI measurement occasion of the CLI resource, and transmit the dynamic indication of the validity of the CLI measurement occasion of the CLI resource to the UE.

### BRIEF DESCRIPTION OF THE DRAWINGS

FIG. 1 illustrates an example of a wireless communications system in accordance with aspects of the present disclosure.

FIG. 2 illustrates an example time division duplex (TDD) uplink (UL)/downlink (DL) configuration for three adjacent cells in accordance with aspects of the present disclosure.

FIG. 3 illustrates an example radio resource control (RRC) information element that configures a list of CLI measurement resources in accordance with aspects of the present disclosure.

FIG. 4 illustrates an example of a UE 400 in accordance with aspects of the present disclosure.

FIG. 5 illustrates an example of a processor 500 in accordance with aspects of the present disclosure.

FIG. 6 illustrates an example of a network equipment (NE) 600 in accordance with aspects of the present disclosure.

FIG. 7 illustrate a flowcharts of method performed by a UE in accordance with aspects of the present disclosure.

FIG. 8 illustrate a flowcharts of method performed by a NE in accordance with aspects of the present disclosure.

### DETAILED DESCRIPTION

Generally, the present disclosure describes systems, methods, and apparatus for interference handling in dynamic time division duplex operation. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In Rel-16 third generation partnership project (3GPP) new radio (NR), two types of CLI measurements, sounding reference signals (SRS) reference signal received power (SRS-RSRP) and CLI reference signal strength indicator (CLI-RSSI), are specified. According to 3GPP TS 38.215 (incorporated herein by reference). SRS-RSRP is defined as linear average of power contributions (in Watt) of resource elements carrying SRS. SRS-RSRP may be measured over the configured resource elements within a considered measurement frequency bandwidth in configured measurement time occasions. CLI-RSSI is defined as linear average of the total received power (in Watt) observed only in configured orthogonal frequency-division multiplexing (OFDM) symbols of a configured measurement time resource(s), in a configured measurement bandwidth from all sources, including co-channel serving and non-serving cells, adjacent channel interference, thermal noise etc. For frequency range 1, the reference point for the measurements shall be the antenna connector of a UE. For frequency range 2, the measurements may be done based on combined signal from antenna elements corresponding to a given receiver branch. For frequency range 1 and 2, if receiver diversity is in use by the UE, the reported measurement value shall not be lower than the corresponding measurement value of any of the individual receiver branches.

In Rel-16 3GPP NR, SRS resources configured for SRS-RSRP measurement for CLI in a DL bandwidth part (BWP) comprise subcarrier spacing same as subcarrier spacing of the DL BWP. A UE is not expected to measure SRS-RSRP using an SRS-RSRP measurement resource which is not fully confined within the DL BWP. The UE is not expected to measure more than 32 SRS resources, and the UE is not expected to receive more than 8 SRS resources in a slot.

In unpaired spectrum, TDD, splitting a radio resource between downlink and uplink in time-domain has been used to avoid interference (e.g., uplink and downlink interference within a network entity and intra-cell UE-to-UE interference). However, when different TDD DL and UL patterns are used between neighboring cells. UL transmission in one cell may interfere with DL reception in another cell, which is known as UE-to-UE CLI.

In 3GPP NR, dynamic/flexible allocation of DL and UL in time via downlink control information (DCI) signaling, i.e. dynamic TDD, is allowed to reduce latency and to efficiently use radio resources in unpaired spectrum. To fully exploit the dynamic TDD feature in NR, effective interference management considering dynamically varying interference level may be necessary.

When a cell in unpaired spectrum operates with semi-statically configured flexible symbols, existence and level of cross-link interference may depend on dynamic usage of the semi-statically configured flexible symbols. In one embodiment, a UE receives a CLI measurement configuration, where the CLI measurement configuration semi-statically configures potential one or multiple CLI measurement occasions (e.g. multiple CLI measurement slots) within a CLI measurement periodicity. Further, the UE receives a dynamic indication for a valid CLI measurement occasion, where the UE needs to perform measurement, from semi-statically configured one or multiple potential CLI measurement occasions. A network entity determines and indicates validity of a configured CLI measurement occasion based on dynamic usage of semi-statically configured flexible symbols within the configured CLI measurement occasion. In one example, the validity of the configured CLI measurement occasion is determined based on information of time-domain resource utilization of a neighboring cell. In another example, the network entity receives the information of time-domain resource utilization of the neighboring cell from another network entity.

In Rel-16 NR, a UE assumes that a CLI measurement resource is always valid/available and is expected to perform CLI measurement for all configured measurement occasions. When communication directions of flexible symbols change dynamically and accordingly, existence of dominant CLI changes dynamically, the UE may not be able to measure a CLI level accurately based on semi-statically configured CLI measurement occasions.

In the proposed solutions described herein, however, UE measurement can accurately reflect the CLI level even with dynamic TDD operation, since the UE can perform CLI measurement only when CLI exists based on dynamic indication from a network entity. This disclosure presents methods to handle dynamic cross-link interference to improve TDD UL/DL configuration flexibility in unpaired spectrum.

Aspects of the present disclosure are described in the context of a wireless communications system.

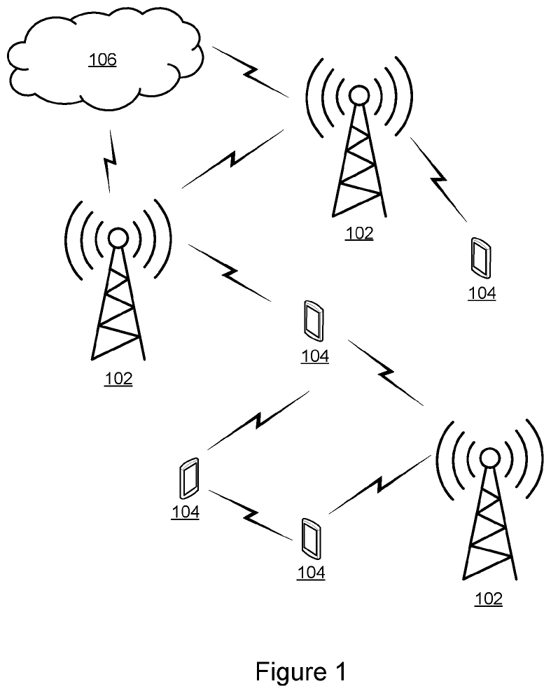

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX). IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 KHZ) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHZ), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations. FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing: a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 KHz subcarrier spacing; and a fourth numerology (e.g., p=3), which includes 120 kHz subcarrier spacing.

Regarding slot configuration, according to TS 38.213, if the UE is additionally provided tdd-UL-DL-ConfigurationDedicated, the parameter tdd-UL-DL-ConfigurationDedicated overrides only flexible symbols per slot over the number of slots as provided by tdd-UL-DL-ConfigurationCommon.

The tdd-UL-DL-ConfigurationDedicated provides a set of slot configurations by slotSpecificConfigurationsToAddModList for each slot configuration from the set of slot configurations, a slot index for a slot provided by slotindex, and a set of symbols for a slot by symbols where if symbols=allDownlink, all symbols in the slot are downlink: if symbols=allUplink, all symbols in the slot are uplink; and/or if symbols=explicit, nrofDownlinkSymbols provides a number of downlink first symbols in the slot and nrofUplinkSymbols provides a number of uplink last symbols in the slot. If nrofDownlinkSymbols is not provided, there are no downlink first symbols in the slot and if nrofUplinkSymbols is not provided, there are no uplink last symbols in the slot. The remaining symbols in the slot are flexible.

If a UE is not configured to monitor physical downlink control channel (PDCCH) for DCI format 2_0, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, the UE receives physical downlink shared channel (PDSCH) or channel state information reference signal (CSI-RS) in the set of symbols of the slot if the UE receives a corresponding indication by a DCI format and the UE transmits physical uplink shared channel (PUSCH), physical uplink control channel (PUCCH), physical random access channel (PRACH), or SRS in the set of symbols of the slot if the UE receives a corresponding indication by a DCI format, a random access response (RAR) UL grant, fallbackRAR UL grant, or successRAR.

For a set of symbols of a slot that are indicated to a UE as flexible by tdd-UL-DL-ConfigurationCommon, and tdd-UL-DL-ConfigurationDedicated if provided, the UE does not expect to receive both dedicated higher layer parameters configuring transmission from the UE in the set of symbols of the slot and dedicated higher layer parameters configuring reception by the UE in the set of symbols of the slot.

Regarding the UE procedure for determining slot format, a slot format indicator (SFI)-index field value in a DCI format 2_0 indicates to a UE a slot format for each slot in a number of slots for each DL BWP or each UL BWP starting from a slot where the UE detects the DCI format 2_0. The number of slots is equal to or larger than a PDCCH monitoring periodicity for DCI format 2_0. The SFI-index field includes max {[log₂(maxSFIindex+1)] 1} bits where maxSFIindex is the maximum value of the values provided by corresponding slotFormatCombinationId. A slot format is identified by a corresponding format index as provided in Table 11.1.1-1 where ‘D’ denotes a downlink symbol, ‘U’ denotes an uplink symbol, and ‘F’ denotes a flexible symbol.

For a set of symbols of a slot that are indicated as downlink/uplink by tdd-UL-DL-ConfigurationCommon, or tdd-UL-DL-ConfigurationDedicated, the UE does not expect to detect a DCI format 2_0 with an SFI-index field value indicating the set of symbols of the slot as uplink/downlink, respectively, or as flexible.

For a set of symbols of a slot indicated to a UE as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE, and if the UE detects a DCI format 2_0 providing a format for the slot using a slot format value other than 255.

If one or more symbols from the set of symbols are symbols in a control resource set (CORESET) configured to the UE for PDCCH monitoring, the UE receives PDCCH in the CORESET only if an SFI-index field value in DCI format 2_0 indicates that the one or more symbols are downlink symbols.

If an SFI-index field value in DCI format 2_0 indicates the set of symbols of the slot as flexible and the UE detects a DCI format indicating to the UE to receive PDSCH or CSI-RS in the set of symbols of the slot, the UE receives PDSCH or CSI-RS in the set of symbols of the slot.

If an SFI-index field value in DCI format 2_0 indicates the set of symbols of the slot as flexible and the UE detects a DCI format, a RAR UL grant, fallbackRAR UL grant, or successRAR indicating to the UE to transmit PUSCH, PUCCH, PRACH, or SRS in the set of symbols of the slot the UE transmits the PUSCH, PUCCH, PRACH, or SRS in the set of symbols of the slot.

If an SFI-index field value in DCI format 2_0 indicates the set of symbols of the slot as flexible, and the UE does not detect a DCI format indicating to the UE to receive PDSCH or CSI-RS, or the UE does not detect a DCI format, a RAR UL, fallbackRAR UL grant, or successRAR grant indicating to the UE to transmit PUSCH, PUCCH, PRACH, or SRS in the set of symbols of the slot, the UE does not transmit or receive in the set of symbols of the slot.

If the UE is configured by higher layers to receive PDSCH or CSI-RS in the set of symbols of the slot, the UE receives the PDSCH or the CSI-RS in the set of symbols of the slot only if an SFI-index field value in DCI format 2_0 indicates the set of symbols of the slot as downlink and, if applicable, the set of symbols is within remaining channel occupancy duration.

If the UE is configured by higher layers to receive DL positioning reference signal (PRS) in the set of symbols of the slot, the UE receives the DL PRS in the set of symbols of the slot only if an SFI-index field value in DCI format 2_0 indicates the set of symbols of the slot as downlink or flexible.

If the UE is configured by higher layers to transmit PUCCH, or PUSCH, or PRACH in the set of symbols of the slot, the UE transmits the PUCCH, or the PUSCH, or the PRACH in the slot only if an SFI-index field value in DCI format 2_0 indicates the set of symbols of the slot as uplink.

If the UE is configured by higher layers to transmit SRS in the set of symbols of the slot, the UE transmits the SRS only in a subset of symbols from the set of symbols of the slot indicated as uplink symbols by an SFI-index field value in DCI format 2_0.

A UE does not expect to detect an SFI-index field value in DCI format 2_0 indicating the set of symbols of the slot as downlink and also detect a DCI format, a RAR UL grant, fallbackRAR UL grant, or successRAR indicating to the UE to transmit SRS, PUSCH, PUCCH, or PRACH, in one or more symbols from the set of symbols of the slot.

A UE does not expect to detect an SFI-index field value in DCI format 2_0 indicating the set of symbols of the slot as downlink or flexible if the set of symbols of the slot includes symbols corresponding to any repetition of a PUSCH transmission activated by an UL Type 2 grant PDCCH as described in Clause 10.2.

A UE does not expect to detect an SFI-index field value in DCI format 2_0 indicating the set of symbols of the slot as uplink and also detect a DCI format indicating to the UE to receive PDSCH or CSI-RS in one or more symbols from the set of symbols of the slot.

If a UE is configured by higher layers to receive a CSI-RS or a PDSCH in a set of symbols of a slot and the UE detects a DCI format 2_0 with a slot format value other than 255 that indicates a slot format with a subset of symbols from the set of symbols as uplink or flexible, or the UE detects a DCI format indicating to the UE to transmit PUSCH, PUCCH, SRS, or PRACH in at least one symbol in the set of the symbols, the UE cancels the CSI-RS reception in the set of symbols of the slot or cancels the PDSCH reception in the slot.

For operation with shared spectrum channel access, if a UE is configured by higher layers to receive a CSI-RS and the UE is provided CO-DurationsPerCell, for a set of symbols of a slot that are indicated as downlink or flexible by tdd-UL-DL-ConfigurationCommon or tdd-UL-DL-ConfigurationDedicated, or when tdd-UL-DL-ConfigurationCommon and tdd-UL-DL-ConfigurationDedicated are not provided, the UE cancels the CSI-RS reception in the set of symbols of the slot that are not within the remaining channel occupancy duration.

If a UE is configured by higher layers to receive a DL PRS in a set of symbols of a slot and the UE detects a DCI format 2_0 with a slot format value other than 255 that indicates a slot format with a subset of symbols from the set of symbols as uplink, or the UE detects a DCI format indicating to the UE to transmit PUSCH, PUCCH, SRS, or PRACH in at least one symbol in the set of the symbols, the UE cancels the DL PRS reception in the set of symbols of the slot.

If a UE is configured by higher layers to transmit SRS, or PUCCH, or PUSCH, or PRACH in a set of symbols of a slot and the UE detects a DCI format 2_0 with a slot format value other than 255 that indicates a slot format with a subset of symbols from the set of symbols as downlink or flexible, or the UE detects a DCI format indicating to the UE to receive CSI-RS or PDSCH in a subset of symbols from the set of symbols, then the UE does not expect to cancel the transmission in symbols from the set of symbols that occur, relative to a last symbol of a CORESET where the UE detects the DCI format 2_0 or the DCI format, after a number of symbols that is smaller than the PUSCH preparation time T_{proc,2} for the corresponding PUSCH processing capability, e.g., according to TS 38.214, assuming d_{2,1}=1 and μ corresponds to the smallest SCS configuration between the SCS configuration of the PDCCH carrying the DCI format 2_0 or the DCI format and the SCS configuration of the SRS, PUCCH, PUSCH or μᵣ, where μᵣ corresponds to the SCS configuration of the PRACH if it is 15 kHz or higher; otherwise μᵣ=0, and/or the UE cancels the PUCCH, or the PUSCH, or an actual repetition of the PUSCH, e.g., according to TS 38.214, determined from Clauses 9 and 9.2.5 or Clause 6.1 of TS 38.214, or the PRACH transmission in remaining symbols from the set of symbols and cancels the SRS transmission in remaining symbols from the subset of symbols.

If a UE is configured by higher layers to receive a CSI-RS or detects a DCI format 0_1 indicating to the UE to receive a CSI-RS in one or more resource block (RB) sets and a set of symbols of a slot, and the UE detects a DCI format 2_0 with bitmap indicating that any RB set from the one or more RB sets is not available for reception, the UE cancels the CSI-RS reception in the set of symbols of the slot.

A UE assumes that flexible symbols in a CORESET configured to the UE for PDCCH monitoring are downlink symbols if the UE does not detect an SFI-index field value in DCI format 2_0 indicating the set of symbols of the slot as flexible or uplink and the UE does not detect a DCI format indicating to the UE to transmit SRS, PUSCH, PUCCH, or PRACH in the set of symbols.

For a set of symbols of a slot that are indicated as flexible by tdd-UL-DL-ConfigurationCommon, and tdd-UL-DL-ConfigurationDedicated if provided, or when tdd-UL-DL-ConfigurationCommon, and tdd-UL-DL-ConfigurationDedicated are not provided to the UE, and if the UE does not detect a DCI format 2_0 providing a slot format for the slot the UE receives PDSCH or CSI-RS in the set of symbols of the slot if the UE receives a corresponding indication by a DCI format, the UE transmits PUSCH, PUCCH, PRACH, or SRS in the set of symbols of the slot if the UE receives a corresponding indication by a DCI format, a RAR UL grant, fallbackRAR UL grant, or successRAR and/or the UE receives PDCCH.

If the UE is configured by higher layers to receive PDSCH in the set of symbols of the slot, the UE does not receive the PDSCH in the set of symbols of the slot. If the UE is configured by higher layers to receive CSI-RS in the set of symbols of the slot, the UE does not receive the CSI-RS in the set of symbols of the slot, except when UE is provided CO-DurationsPerCell and the set of symbols of the slot are within the remaining channel occupancy duration. If the UE is configured by higher layers to receive DL PRS in the set of symbols of the slot, the UE receives the DL PRS. If the UE is configured by higher layers to transmit SRS, or PUCCH, or PUSCH, or PRACH in the set of symbols of the slot and the UE is not provided enableConfiguredUL, the UE does not transmit the PUCCH, or the PUSCH, or the PRACH in the slot and does not transmit the SRS in symbols from the set of symbols in the slot, if any, starting from a symbol that is after PUSCH preparation time T_{proc,2} for the corresponding PUSCH timing capability, e.g., according to TS 38.214, assuming d_{2,1}=1 after a last symbol of a CORESET where the UE is configured to monitor PDCCH for DCI format 2_0 and u corresponds to the smallest SCS configuration between the SCS configuration of the PDCCH carrying the DCI format 2_0) and the SCS configuration of the SRS, PUCCH, PUSCH or μᵣ, where μ, corresponds to the SCS configuration of the PRACH if it is 15 kHz or higher: otherwise μᵣ=0. The UE does not expect to cancel the transmission of the SRS, or the PUCCH, or the PUSCH, or the PRACH in symbols from the set of symbols in the slot, if any, starting before a symbol that is after the PUSCH preparation time T_{proc,2} for the corresponding PUSCH timing capability, e.g., according to TS 38.214, assuming d_{2,1}=1 after a last symbol of a CORESET where the UE is configured to monitor PDCCH for DCI format 2_0 and u corresponds to the smallest SCS configuration between the SCS configuration of the PDCCH carrying the DCI format 2_0 and the SCS configuration of the SRS, PUCCH, PUSCH or μᵣ, where μᵣ corresponds to the SCS configuration of the PRACH if it is 15 kHz or higher: otherwise μᵣ=0.

If the UE is configured by higher layers to transmit SRS, or PUCCH, or PUSCH, or PRACH in the set of symbols of the slot and the UE is provided enableConfiguredUL, the UE can transmit the SRS, or PUCCH, or PUSCH, or PRACH, respectively.

The solutions described herein, in one embodiment, are directed to dynamic indication of valid CLI measurement occasions. In one embodiment, when a cell in unpaired spectrum operates with semi-statically configured flexible symbols, existence of cross-link interference may depend on dynamic usage of the configured flexible symbols.

In one embodiment, a UE receives a CLI measurement configuration, where the CLI measurement configuration semi-statically configures potential one or multiple measurement time instances or measurement occasions (e.g., multiple measurement slots) within a measurement periodicity. Further, the UE receives a dynamic indication of a valid measurement time instance or measurement occasion, where the UE needs to perform measurement, from semi-statically configured one or multiple potential measurement time instances or measurement occasions.

In some implementations, the measurement configuration comprises at least one of a set of one or more SRS resource configurations for CLI SRS-RSRP and a set of one or more RSSI resource configurations for CLI-RSSI. An SRS resource configuration may indicate an SRS resource (time-frequency resource elements) within a configured frequency bandwidth and its periodicity characteristics. A RSSI resource configuration may indicate a CLI-RSSI resource comprising a position of OFDM symbols, a set of RBs, and periodicity and slot offset time occasions for the CLI-RSSI resource.

In some implementations, a CLI measurement time instance or measurement occasion is considered as valid if it completely overlaps with downlink symbols e.g., semi-static downlink symbols and flexible symbols indicated or assumed as downlink symbols. In some implementations, dynamic indication of a valid CLI measurement time instance or measurement occasion may only be indicated for or apply to a measurement time instance or measurement occasion that partially or completely overlaps with flexible symbols. A CLI measurement time instance or measurement occasion that completely overlap with semi-static downlink symbols are assumed to be valid.

In one implementation, a UE receives an explicit dynamic indication of a valid CLI measurement occasion via DCI or a medium access control (MAC) control element (CE). For example, a bitfield in DCI (e.g. DCI with DL assignment and/or DCI with UL grant) is configured to indicate availability of one or more configured CLI measurement occasions. For example, each bit in the DCI bitfield indicates availability of an associated set of CLI measurement occasions (e.g., the set may comprise at least one CLI measurement occasion). Additionally, the UE may receive a validity duration for the explicit dynamic indication.

In another implementation, a UE receives an implicit dynamic indication of a valid CLI measurement occasion via an SFI in a DCI format 2_0. In one example, the CLI measurement occasion is considered as valid, if the SFI indicates that all configured measurement symbols of the CLI measurement occasion are downlink symbols. In another example, the CLI measurement occasion is considered as valid, if the SFI indicates that a configured or predefined number of symbols from the configured measurement symbols of the CLI measurement occasion are downlink symbols. Further, the UE performs the CLI measurement on the DL symbols from the configured measurement symbols of the CLI measurement occasion.

In one example, if a UE does not receive a dynamic indication to transmit in semi-statically configured flexible symbols of a configured CLI measurement slot, the UE performs CLI measurement in the configured CLI measurement slot.

In another example, if a UE receives a dynamic indication to receive in semi-statically configured flexible symbols of a configured CLI measurement slot, the UE performs CLI measurement in the configured CLI measurement slot.

In yet another implementation, a UE receives an indication that a subset of configured one or multiple CLI measurement occasions are always valid CLI measurement occasions. In an example, the indication is included as a part of measurement occasion configuration.

In an implementation, a UE is not expected to receive more than one indication (e.g., DCI) in a time window: indicating different validity status/state for a CLI measurement occasion. In one embodiment, the time window can be one slot or a predefined number of symbols/slots (e.g., depending on SCS or depending on a processing timeline such as PUSCH preparation time or PDSCH processing time). In one embodiment, the time window starts from a time associated with reception of the indication (e.g., the time where the DCI is received).

In an implementation, a UE receives a first indication (e.g., via RRC, MAC CE, or DCI signaling). The first indication may enable/disable the UE to perform CLI measurement during a duration where the UE has been skipping PDCCH monitoring.

If the UE does not receive a dynamic indication to transmit in semi-statically configured flexible symbols of a configured CLI measurement slot (or measurement occasion), and if the UE has received a PDCCH skipping indication indicating skipping PDCCH monitoring for a duration including the CLI measurement slot, the UE performs CLI measurement in the configured CLI measurement slot if the UE has been indicated to perform CLI measurement in such condition (e.g., via the first indication).

The UE may be expected to perform CLI_measurement in the configured CLI measurement slot if the UE has not received a PDCCH skipping indication within ‘T’ time units (e.g., symbols) prior to the CLI measurement occasion.

In an implementation, a CLI measurement occasion is considered as valid, if an SFI indicates that a configured or predefined number of symbols from configured measurement symbols of a CLI measurement occasion are downlink symbols, and if the SFI is received at least ‘X’ time units (slots/symbols) prior to the CLI measurement occasion.

In an implementation, a CLI measurement occasion for a UE is considered as unavailable, if a dynamic unavailability indication is received/detected at least ‘X’ time units (e.g. slots, symbols) prior to the CLI measurement occasion, where X is predefined or configured and may be dependent on UE capability. Otherwise, the CLI measurement occasion is considered as available, and the UE performs CLI measurement on the CLI measurement occasion. In an example, a value ‘I’ for a bit of a bitmap of unavailability indication indicates unavailability of an associated CLI measurement occasion, and a value ‘0’ indicates no change to a current assumption for availability or unavailability of the associated CLI measurement occasion.

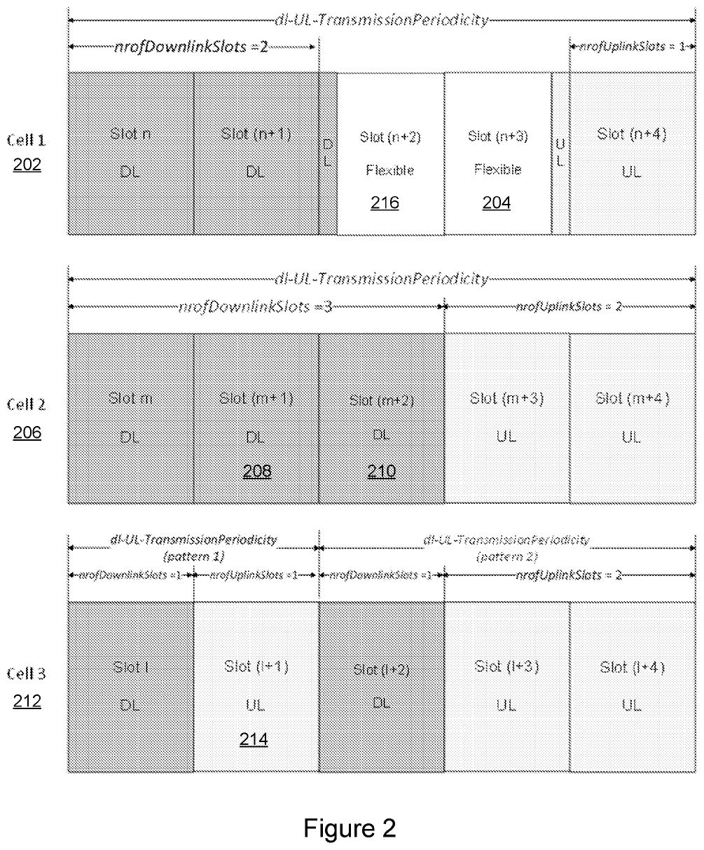

In an example, three adjacent cells have different semi-static UL/DL configurations, as shown in FIG. 2. UE 1 in Cell 1 202 is configured with CLI measurement (e.g. CLI-RSSI or SRS-RSRP) in slot (n+3) 204 with a periodicity of 5 slots. That is, a CLI measurement occasion is configured in the slot (n+3) 204 for the UE 1. If a network entity decides to use cell-specifically configured flexible symbols in the slot (n+3) 204 as DL symbols, the network entity indicates to the UE 1 via scheduling DCI or group-common DCI that the CLI measurement occasion in the slot (n+3) 204 is a valid CLI measurement occasion. Since the slot (n+3) 204 includes cell-specifically configured flexible symbols, UE 1 determines whether to perform the CLI measurement on the slot (n+3) 204 based on scheduling DCI including a bitfield for availability of the CLI measurement occasion and/or SFI in a DCI format 2_0.

In another example related to FIG. 2, UE 2 in Cell 2 206 is configured with CLI measurement in slot (m+1) 208 and slot (m+2) 210 with periodicity of 5 slots. Since slot (1+1) 214 in Cell 3 212 is configured as an UL slot, a network entity configures the CLI measurement occasion in the slot (m+1) 208 of Cell 2 206 to be always valid/available for CLI measurement. On the other hand, CLI from Cell 1 202 exists only when flexible symbols in slot (n+2) 216 of Cell 1 202 is used as UL symbols. Thus, the network entity configures the CLI measurement occasion in the slot (m+2) 210 of Cell 2 206 to be dynamically activated and deactivated, and the UE 2 determines validity/availability of the CLI measurement occasion in the slot (m+2) 210 based on a dynamic indication via DCI.

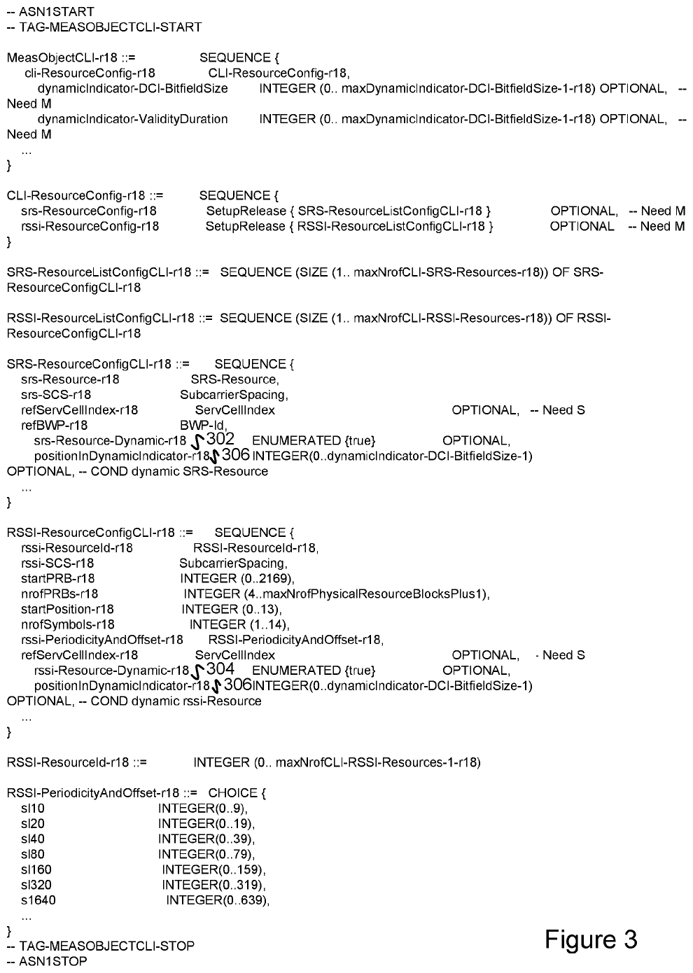

FIG. 3 provides an exemplary RRC Information Element (IE) MeasObjectCLI that configures a list of CLI measurement resources (e.g., SRS resources, RSSI resources) and a DCI bitfield size for dynamic availability indication. A CLI measurement resource can be configured with a dynamic availability indication based on parameter rssi-Resource-Dynamic-r18 304 or srs-Resource-Dynamic-r18 302 set to “true” and parameter positionInDynamicIndicator-r18306.

The following table describes different elements of the MeasObjectCLI IE:

CLI-ResourceConfig field descriptions
srs-ResourceConfig
SRS resources to be used for CLI measurements.
rssi-ResourceConfig
CLI-RSSI resources to be used for CLI measurements.
MeasObjectCLI field descriptions
cli-ResourceConfig
SRS and/or CLI-RSSI resource configuration for CLI measurement.
dynamicIndicator-DCI-BitfieldSize
The size of the DCI bitfield for dynamic indication of CLI measurement resource
availability
dynamicIndicator-ValidityDuration
The validity duration of dynamic availability indication of a CLI measurement
resource
SRS-ResourceConfigCLI field descriptions
refBWP
DL BWP id that is used to derive the reference point of the SRS resource
refServCellIndex
The index of the reference serving cell that the refBWP belongs to. If this field is
absent, the reference serving cell is PCell.
srs-SCS
Subcarrier spacing for SRS. Only the values 15, 30 kHz or 60 kHz (FR1), and 60 or
120 kHz (FR2) are applicable.
srs-Resource-Dynamic
Indicates that UE is configured to receive a dynamic indication of availability of this
SRS resource.
positionInDynamicIndicator
The bit position of the dynamic availability indicator for this SRS resource within the
DCI bitfield. This field exists only if srs-Resource-Dynamic is set to ‘true’.
RSSI-ResourceConfigCLI field descriptions
nrofPRBs
Allowed size of the measurement BW. Only multiples of 4 are allowed. The smallest
configurable number is the minimum of 4 and the width of the active DL BWP. If the
configured value is larger than the width of the active DL BWP, the UE shall assume that the
actual CLI-RSSI resource bandwidth is within the active DL BWP.
nrofSymbols
Within a slot that is configured for CLI-RSSI measurement (see slotConfiguration), the
UE measures the RSSI from startPosition to startPosition + nrofSymbols − 1. The configured
CLI-RSSI resource does not exceed the slot boundary of the reference SCS. If the SCS of
configured DL BWP(s) is larger than the reference SCS, network configures startPosition and
nrofSymbols such that the configured CLI-RSSI resource not to exceed the slot boundary
corresponding to the configured BWP SCS. If the reference SCS is larger than SCS of
configured DL BWP(s), network ensures startPosition and nrofSymbols are integer multiple of
reference SCS divided by configured BWP SCS.
refServCellIndex
The index of the reference serving cell. Frequency reference point of the RSSI resource
is subcarrier 0 of CRB0 of the reference serving cell. If this field is absent, the reference
serving cell is PCell.
rssi-PeriodicityAndOffset
Periodicity and slot offset for this CLI-RSSI resource. All values are in “number of
slots”. Value sl1 corresponds to a periodicity of 1 slot, value sl2 corresponds to a periodicity of
2 slots, and so on. For each periodicity the corresponding offset is given in number of slots.
rssi-SCS
Reference subcarrier spacing for CLI-RSSI measurement. Only the values 15, 30 kHz
or 60 kHz (FR1), and 60 or 120 kHz (FR2) are applicable. UE performs CLI-RSSI
measurement with the SCS of the active bandwidth part within the configured CLI-RSSI
resource in the active BWP regardless of the reference SCS of the measurement resource.
startPosition
OFDM symbol location of the CLI-RSSI resource within a slot.
startPRB
Starting PRB index of the measurement bandwidth. For the case where the reference
subcarrier spacing is smaller than subcarrier spacing of active DL BWP(s), network configures
startPRB and nrofPRBs are as a multiple of active BW SCS divided by reference SCS.
rssi-Resource-Dynamic
Indicates that UE is configured to receive a dynamic indication of availability of this
RSSI resource.
positioninDynamicIndicator
The bit position of the dynamic availability indicator for this RSSI resource within the
DCI bitfield. This field exists only if rssi-Resource-Dynamic is set to ‘true’.

Regarding Inter-Next Generation Node B (gNB) coordination, to employ the methods disclosed herein, base stations may need to perform signaling for coordination prior to, and/or during, the CLI management operation.

Regarding Inter-gNB coordination on Xn interface, in some embodiments, a first base station gNB1 may send a message/IE to a second base station gNB2, wherein the message/IE comprises an indication of whether flexible slots/symbols in a gNB1 cell are to be used and/or whether the flexible slots/symbols are to be used for uplink or downlink. The message/IE may be communicated on an Xn interface or any direct backhaul link between the base stations.

In several embodiments, gNB2 may receive a TDD configuration from gNB1. This configuration may be the Intended TDD UL-DL IE, specified in TS 38.423, or a new IE dedicated to realization of the CLI management methods disclosed herein.

In one embodiment, the message/IE may indicate that any or all slots/symbols configured as flexible may be used. This embodiment may be particularly useful when flexible slots/symbols may or may not be used at all due to variations in the traffic load in the gNB1 cell.

In one example, the indication may be interpreted by gNB2 in a semi-static manner, i.e., the indication remains valid until it is overridden by another indication from gNB1.

In another example, the indication may be dynamic, i.e., it may be associated with flexible slots/symbols in a periodicity (which may be signaled or configured by the OAM (Operations, Administration, and Maintenance)), for all flexible slots/symbols until a timer expires, or the like.

In another embodiment, the message/IE may indicate that certain flexible slots/symbols may be used. This embodiment provides additional flexibility in the face of traffic load variations on the gNB1 cell at the cost of additional overhead because the resulting message/IE may be larger.

In one example, each flexible symbol may be assigned a bit in a bitmap field, wherein a value of ‘1’, for example, may indicate that the flexible symbol is to be used (or is not guaranteed to be unused). A value of ‘O’ in the bitmap field may then indicate that the associated flexible symbol is expected (or guaranteed) to be unused. In this example, bits in the bitmap field may be associated one-by-one and in the same order, with flexible symbols indicated by the Intended TDD UL-DL IE or the like.

In another example, all flexible symbols in each slot may be assigned a bit in a bitmap field, wherein a value of ‘1’, for example, may indicate that all the flexible symbols in an associated slot are to be used (or are not guaranteed to be unused). A value of ‘0’ in the bitmap field may then indicate that all the flexible symbols in the associated slot are expected (or guaranteed) to be unused. In this example, bits in the bitmap field may be associated one-by-one and in the same order, with slots indicated by the Intended TDD UL-DL IE or the like. gNB2 may discard/neglect any bits in the bitmap field that are associated with slots that do not comprise flexible symbols.

In yet another example, all flexible symbols in each slot may be assigned a bit in a bitmap field, but slots that do not comprise flexible symbols may not be assigned bit in the bitmap field. Here, similarly, a value of ‘1’, for example, may indicate that all the flexible symbols in an associated slot are to be used (or are not guaranteed to be unused). A value of ‘0’ in the bitmap field may then indicate that all the flexible symbols in the associated slot are expected (or guaranteed) to be unused. In this example, bits in the bitmap field may be associated one-by-one and in the same order, with slots indicated by the Intended TDD UL-DL IE or the like that comprise at least one flexible symbol.

In several examples, the indication may be interpreted as semi-static, i.e., the information remains valid until overridden by another indication from gNB1. Alternatively, the indication may be valid for one periodicity (signaled or pre-configured), until a timer expires, or the like.

In several embodiments, a bitmap field may additionally, or alternatively, indicate whether a flexible slot/symbol is to be used for downlink or uplink.

In one example, values of ‘1’ or ‘0’, for example, may indicate that an associated flexible symbol, all flexible symbols in an associated slot, or the like, may be used for downlink or uplink, respectively.

In another example, values of ‘1’ or ‘0’, for example, may indicate that an associated flexible symbol, all flexible symbols in an associated slot, or the like, may be used for downlink or not used, respectively.

In yet another example, values of ‘1’ or ‘0’, for example, may indicate that an associated flexible symbol, all flexible symbols in an associated slot, or the like, may be used for uplink or not used, respectively.

In yet another example, one bit with values of ‘1’ or ‘0’, for example, may indicate that an associated flexible symbol, all flexible symbols in an associated slot, or the like, may be used or may not be used, respectively: while another bit with values of ‘1’ or ‘0’, for example, may indicate that the associated flexible symbol, all flexible symbols in the associated slot, or the like, may be used for downlink or uplink, respectively. The latter bit may be discarded/neglected if the former bit indicates that the associated flexible symbol, all flexible symbols in the associated slot, or the like are not used. The two bits may be in the same bitmap field or in different bitmap fields.

Regarding Inter-gNB coordination on NG interface, a similar signaling may be employed for inter-gNB coordination where gNBs are not directly connected by an Xn interface or an indirect signaling is otherwise preferred or available.

In several embodiments, a configuration may be provided by the core network, for example an Access and Mobility Management Function (AMF) in the core network.

In several embodiments, gNB1 may send a message/IE to the AMF on an NG interface, and then the AMF may forward information of the message/IE to gNB2 on another NG interface. The content of the message/IE from gNB1 to the AMF and/or from the AMF to gNB2 may be similar to the content of the message/IE described earlier for coordination on an Xn interface.

In some embodiments, the AMF may receive messages/IEs from multiple source gNBs, combine the information, and send the information to one or multiple target gNBs. For example, the AMF may apply an AND or OR operation on bitmap fields comprised by the messages/IEs from the source gNBs. In one example, if a value of ‘1’ indicates that a flexible symbol is to be used by a source gNB, the result of an OR operation may indicate to a target gNB that at least one other source gNB intends to use the said flexible symbol (or does not guarantee that the flexible symbol is unused). Other similar operations such as AND, addition, etc. may provide other such information from a group of source gNBs to one or multiple target gNBs that employ the CLI management methods proposed in the present disclosure.

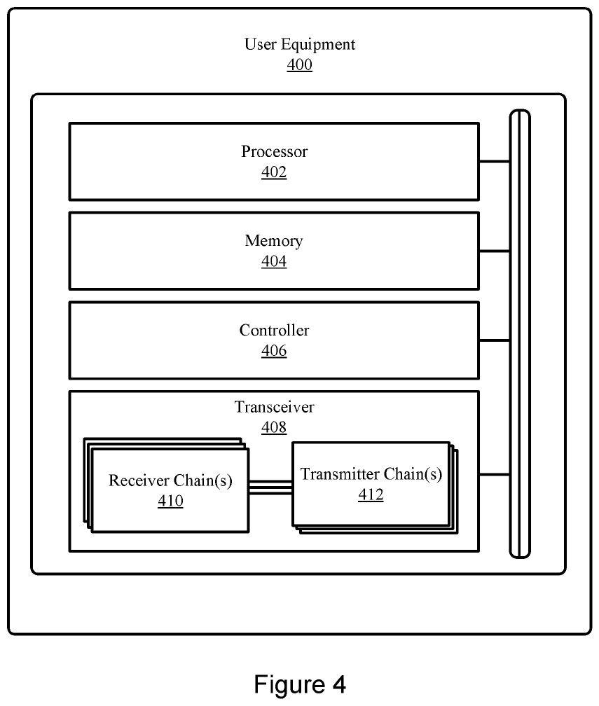

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein.

The UE 400 may be configured to support a means for receiving a CLI measurement configuration, the CLI measurement configuration comprising at least one CLI resource, a CLI resource of the at least one CLI resource configured with a dynamic indication. The UE 400 may be configured to support a means for monitoring the dynamic indication for the CLI resource of the at least one CLI resource. The UE 400 may be configured to support a means for performing a measurement on the CLI resource in response to the dynamic indication not indicating that the CLI resource is unavailable for measurement.

The UE 400 may be configured to support a means for performing the measurement on the CLI resource by performing the measurement on the CLI resource in response to not detecting the dynamic indication.

The UE 400 may be configured to support a means for performing the measurement on the CLI resource irrespective of the dynamic indication in response to the dynamic indication being detected no earlier than a number of time units prior to a starting symbol of a CLI occasion of the CLI resource.

In one embodiment, the dynamic indication is a dynamic availability indication and the UE 400 may be configured to support a means for performing the measurement on the CLI resource by performing the measurement on the CLI resource in response to the dynamic availability indication indicating that the CLI resource is available for measurement.

The UE 400 may be configured to support a means for receiving a validity duration of the dynamic indication. The UE 400 may be configured to support a means for receiving the dynamic indication in DCI.

In one embodiment, the CLI measurement configuration further comprises a size of a bitfield in the DCI for a set of dynamic indications corresponding to a set of CLI resources of the at least one CLI resource. In one embodiment, the CLI resource is further configured with a bit position within the bitfield for the dynamic indication.

The UE 400 may be configured to support a means for receiving a semi-static DL and UL configuration, the semi-static DL and UL configuration comprising at least one semi-static flexible symbol, and wherein the at least one processor is configured to cause the UE to receive the dynamic indication in response to the CLI resource comprising a semi-static flexible symbol of the at least one semi-static flexible symbol.

The controller 406 may manage input and output signals for the UE 400. The controller 406 may also manage peripherals not integrated into the UE 400. In some implementations, the controller 406 may utilize an operating system such as iOS®, ANDROID®. WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receiving the signal over the air or wireless medium. The receiver chain 410 may include at least one amplifier (e.g., a low-noise amplifier (LNA)) configured to amplify the received signal. The receiver chain 410 may include at least one demodulator configured to demodulate the received signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

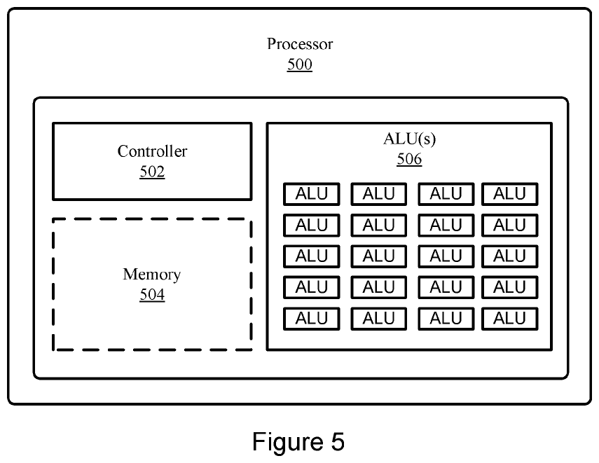

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND. OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for receiving a CLI measurement configuration, the CLI measurement configuration comprising at least one CLI resource, a CLI resource of the at least one CLI resource configured with a dynamic indication. The processor 500 may be configured to or operable to support a means for monitoring the dynamic indication for the CLI resource of the at least one CLI resource. The processor 500 may be configured to or operable to support a means for performing a measurement on the CLI resource in response to the dynamic indication not indicating that the CLI resource is unavailable for measurement.

The processor 500 may be configured to or operable to support a means for performing the measurement on the CLI resource by performing the measurement on the CLI resource in response to not detecting the dynamic indication.

The processor 500 may be configured to or operable to support a means for performing the measurement on the CLI resource irrespective of the dynamic indication in response to the dynamic indication being detected no earlier than a number of time units prior to a starting symbol of a CLI occasion of the CLI resource.

In one embodiment, the dynamic indication is a dynamic availability indication and the processor 500 may be configured to or operable to support a means for performing the measurement on the CLI resource by performing the measurement on the CLI resource in response to the dynamic availability indication indicating that the CLI resource is available for measurement.

The processor 500 may be configured to or operable to support a means for receiving a validity duration of the dynamic indication. The processor 500 may be configured to or operable to support a means for receiving the dynamic indication in DCI.

In one embodiment, the CLI measurement configuration further comprises a size of a bitfield in the DCI for a set of dynamic indications corresponding to a set of CLI resources of the at least one CLI resource. In one embodiment, the CLI resource is further configured with a bit position within the bitfield for the dynamic indication.

The processor 500 may be configured to or operable to support a means for receiving a semi-static DL and UL configuration, the semi-static DL and UL configuration comprising at least one semi-static flexible symbol, and wherein the at least one processor is configured to cause the UE to receive the dynamic indication in response to the CLI resource comprising a semi-static flexible symbol of the at least one semi-static flexible symbol.

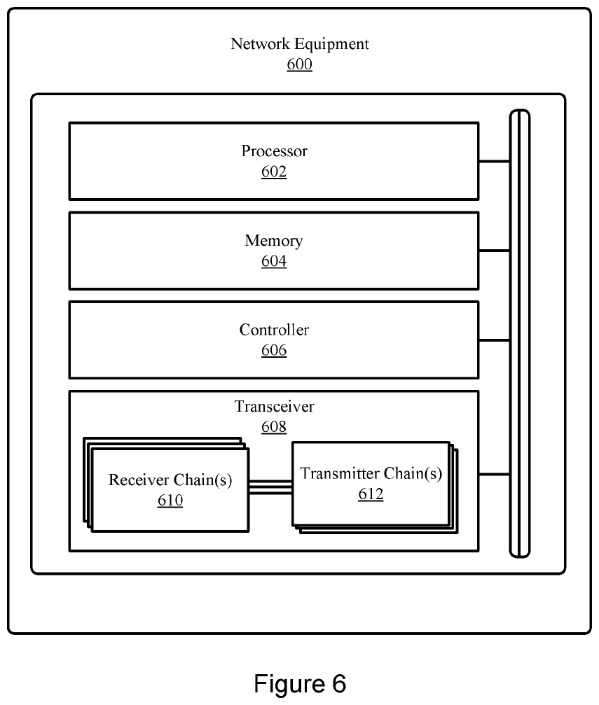

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for transmitting a CLI measurement configuration to a UE, the CLI measurement configuration comprising at least one CLI resource, wherein a CLI resource of the at least one CLI resource is configured with a dynamic indication of a validity of a CLI measurement occasion of the CLI resource. The NE 600 may be configured to support a means for determining the validity of the CLI measurement occasion of the CLI resource. The NE 600 may be configured to support a means for transmitting the dynamic indication of the validity of the CLI measurement occasion of the CLI resource to the UE.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

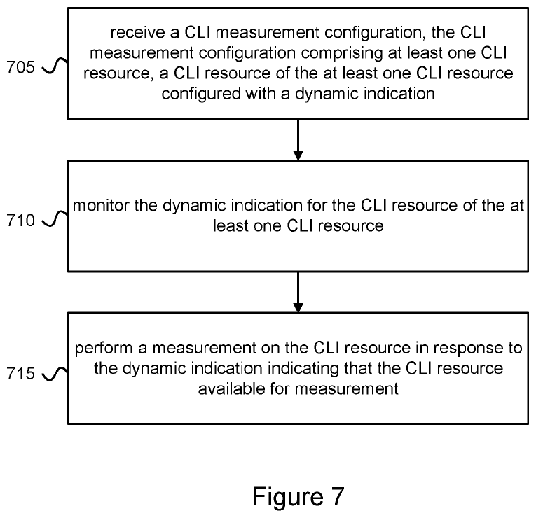

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 705, the method may include receiving a CLI measurement configuration, the CLI measurement configuration comprising at least one CLI resource, a CLI resource of the at least one CLI resource configured with a dynamic indication. The operations of 705 may be performed in accordance with examples as described herein. In some implementations, aspects of the operations of 705 may be performed by a UE as described with reference to FIG. 7.

At 710, the method may include monitoring the dynamic indication for the CLI resource of the at least one CLI resource. The operations of 710 may be performed in accordance with examples as described herein. In some implementations, aspects of the operations of 710 may be performed by a UE as described with reference to FIG. 7.

At 715, the method may include performing a measurement on the CLI resource in response to the dynamic indication not indicating that the CLI resource is unavailable for measurement. The operations of 715 may be performed in accordance with examples as described herein. In some implementations, aspects of the operations of 715 may be performed a UE as described with reference to FIG. 7.

It should be noted that the method described herein describes A possible implementation, and that the operations and the steps may be rearranged or otherwise modified and that other implementations are possible.

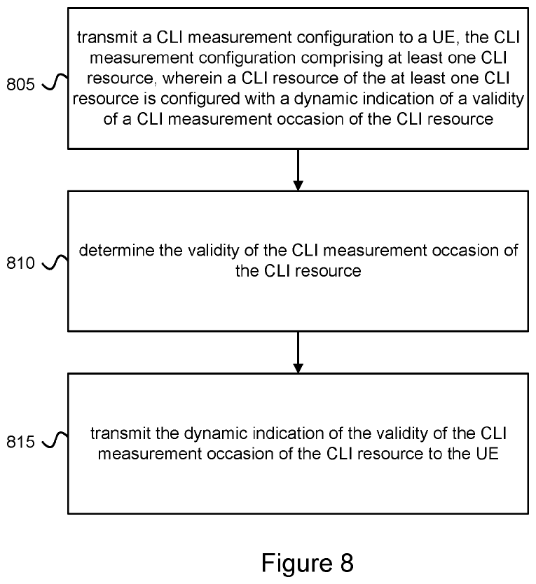

FIG. 8 illustrates a flowchart of a method in accordance with aspects of the present disclosure. The operations of the method may be implemented by a NE as described herein.

In some implementations, the NE may execute a set of instructions to control the function elements of the NE to perform the described functions.

At 805, the method may include transmitting a CLI measurement configuration to a UE, the CLI measurement configuration comprising at least one CLI resource, wherein a CLI resource of the at least one CLI resource is configured with a dynamic indication of a validity of a CLI measurement occasion of the CLI resource. The operations of 805 may be performed in accordance with examples as described herein. In some implementations, aspects of the operations of 805 may be performed by a NE as described with reference to FIG. 8.

At 810, the method may include determining the validity of the CLI measurement occasion of the CLI resource. The operations of 810 may be performed in accordance with examples as described herein. In some implementations, aspects of the operations of 810 may be performed by a NE as described with reference to FIG. 8.

At 815, the method may include transmitting the dynamic indication of the validity of the CLI measurement occasion of the CLI resource to the UE. The operations of 815 may be performed in accordance with examples as described herein. In some implementations, aspects of the operations of 815 may be performed a NE as described with reference to FIG. 8.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a configuration comprising a set of resources, wherein a CLI resource of the set of resources is configured for cross-link interference (CLI) measurement based on an indication;
and
perform the CLI measurement on the resource based at least in part on whether the indication is received, wherein the indication indicates to perform the CLI measurement on the resource.

2. The UE of claim 1, wherein the at least one processor is configured to cause the UE to perform the CLI measurement on the CLI resource in response to not receiving the indication.

3. The UE of claim 1, wherein the at least one processor is configured to cause the UE to perform the CLI measurement on the resource irrespective of the indication and in response to the indication being received no earlier than a number of time units prior to a starting symbol of an occasion associated with the resource.

4. The UE of claim 1, wherein the indication indicates that the resource is available for the CLI measurement.

5. The UE of claim 1, wherein the at least one processor is configured to cause the UE to receive an indication of a validity duration for the resource configured for the CLI measurement.

6. The UE of claim 1, wherein the at least one processor is configured to cause the UE to receive downlink control information (DCI) that indicates the indication that the resource is configured for the CLI measurement.

7. The UE of claim 6, wherein the configuration further comprises a size of a bitfield in the DCI for a set of indications corresponding to the set of CLI resources.

8. The UE of claim 7, wherein the resource is further configured with a bit position within the bitfield for the indication.

9. The UE of claim 1, wherein the at least one processor is configured to cause the UE to receive a semi-static downlink (DL) and uplink (UL) configuration, wherein the semi-static DL and UL configuration indicates one or more semi-static flexible symbols, and wherein the at least one processor is configured to cause the UE to receive the indication in response to the CLI resource being a semi-static flexible symbol of the one or more semi-static flexible symbols.

10. A processor for wireless communication, comprising:
at least one controller coupled with at least one memory and configured to cause the processor to:
receive a configuration comprising a set of resources, wherein a resource of the set of resources is configured for cross-link interference (CLI) measurement based on an indication;
and
perform the CLI measurement on the resource based at least in part on whether the indication is received, wherein the indication indicates to perform the CLI measurement on the resource.

11. (canceled)

12. (canceled)

13. (canceled)

14. (canceled)

15. (canceled)

16. (canceled)

17. (canceled)

18. (canceled)

19. A method performed by a user equipment (UE), the method comprising:
receiving a configuration comprising at a set of resources, wherein a resource of the set of resources is configured for cross-link interference (CLI) measurement based on an indication;
and
performing the CLI measurement on the CLI resource based at least in part on whether the indication is received, wherein the indication indicates to perform the CLI measurement on the resource.

20. A base station for wireless communication, comprising:
at least one memory; and
at least one processor coupled with the at least one memory and configured to cause the base station to:
transmit a configuration comprising a set of resources, wherein a resource of the set of resources is configured for cross-link interference (CLI) measurement;
and
transmit an indication that indicates to perform the CLI measurement on the resource.

21. The base station of claim 20, wherein the indication indicates that the resource is available for the CLI measurement.

22. The base station of claim 20, wherein the at least one processor is configured to cause the base station to transmit an indication of a validity duration for the resource configured for the CLI measurement.

23. The base station of claim 20, wherein the at least one processor is configured to cause the base station to transmit downlink control information (DCI) that indicates the indication that the resource is configured for the CLI measurement.

24. The base station of claim 20, wherein the at least one processor is configured to cause the base station to transmit a semi-static downlink (DL) and uplink (UL) configuration, wherein the semi-static DL and UL configuration indicates one or more semi-static flexible symbols, and wherein the at least one processor is configured to cause the base station to transmit the indication in response to the resource being a semi-static flexible symbol of the one or more semi-static flexible symbols.

25. The method of claim 19, further comprising performing the CLI measurement on the resource in response to not receiving the indication.

26. The method of claim 19, further comprising performing the CLI measurement on the resource irrespective of the indication and in response to the indication being received no earlier than a number of time units prior to a starting symbol of an occasion associated with the resource.

27. The method of claim 19, wherein the indication indicates that the resource is available for the CLI measurement.

28. The method of claim 19, further comprising receiving an indication of a validity duration for the resource configured for the CLI measurement.
